(19) United States
(12) Patent Application Publication
(10) Pub. No.: US 2008/0283723 A1
(43) Pub. Date: Nov. 20, 2008

(54) OPTICAL CHARACTERISTIC MEASURING APPARATUS USING LIGHT REFLECTED FROM OBJECT TO BE MEASURED AND FOCUS ADJUSTING METHOD THEREFOR

(75) Inventors: Tadayoshi FUJIMORI, Ritto-shi (JP); Yoshimi Sawamura, Kyoto-shi (JP); Keiji Yamasaki, Moriyama-shi (JP)

Correspondence Address: DITTHAVONG MORI & STEINER, P.C., 918 Prince St., Alexandria, VA, 22314, US

(73) Assignee: Otsuka Electronics Co., Ltd., Hirakata-shi (JP)

(21) Appl. No.: 12/120,844

(22) Filed: May 15, 2008

(30) Foreign Application Priority Data
May 16, 2007 (JP) 2007-130373

(51) Int. Cl. G02B 27/40; G02B 27/64

(52) U.S. Cl. 250/201.4; 250/201.3

(57) ABSTRACT

An observation light generated by an observation-purpose light source has a beam cross section where the light intensity (light quantity) is substantially uniform. A mask portion masks a part of the observation light so that the light intensity of a region corresponding to a reticle image at the beam cross section is substantially zero. The observation light including a shadow region formed corresponding to the reticle image is reflected from a beam splitter and applied to an object to be measured. Based on the contrast (difference between light and dark parts) of a reflected image corresponding to the reticle image projected on the object to be measured, the focus state of the measurement light on the object to be measured is determined.

### BACKGROUND OF THE INVENTION

1. Field of the Invention

The present invention relates to an optical characteristic measuring apparatus and a focus adjusting method therefor, and more particularly to a technique of easily adjusting the focus in measuring an optical characteristic of an object to be measured whose reflected image has a relatively small contrast.

2. Description of the Background Art

A microspectroscope is known as a typical optical characteristic measuring apparatus for measuring optical characteristics (optical constants) such as the reflectance, refractive index, extinction coefficient, and film thickness of a thin film by applying light to the thin film formed on a substrate for example and spectroscopically measuring the light reflected therefrom.

A conventional microspectroscope is configured for example as disclosed in FIG. 1 of Japanese Patent Laying-Open No. 11-230829. The microspectroscope includes an illuminating optical system directing an illuminating light emitted from a light source through a half mirror to a sample to be measured that is set on a table, and a converging optical system bringing the light reflected from the sample to be measured to a diffraction grating and to a monitoring-purpose optical system. The diffraction grating functions as spectroscopic means for splitting an observation light from a measurement region on the sample to be measured, and converges the spectrum on a line sensor. From the spectrum measured with the line sensor, an optical characteristic is calculated. The monitoring-purpose optical system uses a relay lens to form an enlarged image of the sample to be measured, on a two-dimensional CCD camera. The enlarged image of the sample to be measured that is produced by the CCD camera is used for checking the position of measurement and for rough focusing.

Further, Japanese Patent Laying-Open Nos. 2006-301270 and 2000-137158 disclose a technique of performing autofocusing based on an enlarged image obtained by a monitoring-purpose optical system. Above-referenced Japanese Patent Laying-Open No. 2006-301270 discloses a configuration for calculating a focus value based on a frequency spectrum of a brightness level of an image signal, and Japanese Patent Laying-Open No. 2000-137158 discloses a configuration for calculating a focus value (degree of focus) based on an edge intensity value in a focus area.

These configurations are applicable to the case where an image obtained by capturing an object to be measured (or an image signal thereof) has a contrast (difference between the light and dark parts). In the case where the contrast of an object itself is low, it is difficult to apply the conventional configuration. For example, if an object to be measured is a transparent material such as glass substrate or lens, the light reflected therefrom is weak due to the low reflectance of the material, so that a reflected image is entirely dark and the contrast is low. In contrast, if an object to be measured is a mirror-like sample without design (pattern) formed on its surface, the incident light is almost entirely reflected due to the high reflectance of the sample, so that a reflected image has a low contrast as well. Therefore, the conventional method cannot achieve a sufficient precision in focusing since a difference between a focus value in a focused state and that in an unfocused state is small.

### SUMMARY OF THE INVENTION

The prevent invention has been made for solving the problems as described above. An object of the present invention is to provide an optical characteristic measuring apparatus and a focus adjusting method with which the focus can be adjusted more easily on an object to be measured whose reflected image has a relatively small contrast.

An optical characteristic measuring apparatus according to an aspect of the present invention includes a measurement-purpose light source, an observation-purpose light source, a condensing optical system, an adjusting mechanism, a light injecting portion, a mask portion, a light separating portion, a focus state determining portion, and a position control portion. The measurement-purpose light source generates a measurement light including a component in a wavelength range for measurement of an object to be measured. The observation-purpose light source generates an observation light including a component that can be reflected from the object. The condensing optical system to which the measurement light and the observation light are applied condenses the applied light. The adjusting mechanism is capable of changing a positional relation between the condensing optical system and the object. The light injecting portion, at a predetermined position on an optical path from the measurement-purpose light source to the condensing optical system, injects the observation light. The mask portion, at a predetermined position on an optical path from the observation-purpose light source to the light injecting portion, masks a part of the observation light such that an observation reference image is projected. The light separating portion separates a reflected light generated at the object into a measurement reflected light and an observation reflected light. The focus state determining portion determines a focus state of the measurement light on the object, based on a reflected image included in the observation reflected light and corresponding to the observation reference image. The position control portion controls the adjusting mechanism according to a result of determination of the focus state.

According to the present invention, the partially masked observation light is applied to the object to be measured, so that the observation reference image is projected on the object to be measured. The observation light is reflected from the object to be measured to generate the observation reflected light. The observation reflected light includes the reflected image corresponding to the observation reference image. Since the reflected image corresponding to the observation reference image has a contrast (difference between light and dark parts) given by the observation reference image, the focus state of the observation light on the object to be measured can be accurately determined regardless of the reflectance of the object to be measured.

The measurement light and the observation light are applied through the common condensing optical system to the object to be measured. Therefore, the focus state of the observation light on the object to be measured and the focus state of the measurement light on the object can be regarded as substantially identical to each other.

Therefore, even when the reflected image of the object to be measured has a relatively small contrast, the focus can be adjusted easily based on the observation reflected light including the reflected image corresponding to the observation reference image.

Preferably, the optical characteristic measuring apparatus further includes an image pickup receiving the observation reflected light and outputting an image signal according to the observation reflected light. The focus state determining portion outputs a value indicative of the focus state, based on the image signal from the image pickup.

More preferably, the focus state determining portion outputs the value indicative of the focus state, based on a signal component included in the image signal according to the observation reflected light and corresponding to a pre-set region.

Preferably, the adjusting mechanism is configured to be able to move the object along a light axis of the measurement light, and the position control portion adjusts a distance between the condensing optical system and the object along the light axis, such that the value indicative of the focus state is a maximum.

Preferably, the adjusting mechanism is configured to be able to move the object along a plane orthogonal to a light axis of the measurement light. The position control portion obtains, for each of a plurality of coordinates on the plane, a position of the object in a direction of the light axis at which the value indicative of the focus state is a maximum, the position being obtained as a focus position of each coordinate, and the position control portion searches for a spatial reflection point of the object, based on a plurality of focus positions as obtained.

More preferably, the position control portion obtains a plurality of focus positions respectively for a plurality of coordinates along a first direction on the plane, and obtains a plurality of focus positions respectively for a plurality of coordinates along a second direction orthogonal to the first direction on the plane, and the position control portion determines a spatial reflection point of the object, based on a coordinate at which the focus position has one of maximum and minimum value, in each of the first direction and the second direction.

More preferably, the position control portion moves the object along the plane such that the measurement light and the observation light are applied to the spatial reflection point, and thereafter adjusts a distance between the condensing optical system and the object along the light axis, such that the value indicative of the focus state is a maximum.

Preferably, the image pickup outputs, as the image signal, brightness data of the observation reflected light corresponding to each of a plurality of pixels arranged in a matrix, and the focus state determining portion outputs the value indicative of the focus state, based on a histogram of the brightness data corresponding to each pixel.

According to another aspect of the present invention, a method of adjusting a focus for an optical characteristic measuring apparatus is provided. The optical characteristic measuring apparatus includes a measurement-purpose light source, an observation-purpose light source, a condensing optical system, an adjusting mechanism, a light injecting portion and a light separating portion. The measurement-purpose light source generates a measurement light including a component in a wavelength range for measurement of an object to be measured. The observation-purpose light source generates an observation light including a component that can be reflected from the object. The condensing optical system to which the measurement light and the observation light are applied condenses the applied light. The adjusting mechanism is capable of changing a positional relation between the condensing optical system and the object. The light injecting portion, at a predetermined position on an optical path from the measurement-purpose light source to the condensing optical system, injects the observation light. The mask portion, at a predetermined position on an optical path from the observation-purpose light source to the light injecting portion, masks a part of the observation light such that an observation reference image is projected. The light separating portion separates a reflected light generated at the object into a measurement reflected light and an observation reflected light. The method of adjusting a focus includes the steps of starting generation of the observation light from the observation-purpose light source, determining a focus state of the measurement light on the object, based on a reflected image included in the observation reflected light and corresponding to the observation reference image, and controlling the adjusting mechanism according to a result of determination of the focus state.

Preferably, the optical characteristic measuring apparatus further includes an image pickup receiving the observation reflected light and outputting an image signal according to the observation reflected light. The adjusting mechanism is configured to be able to move the object along a light axis of the measurement light. The step of determining a focus state includes the step of outputting a value indicative of the focus state based on the image signal from the image pickup. The step of controlling the adjusting mechanism includes the step of adjusting a distance between the condensing optical system and the object along the light axis, such that the value indicative of the focus state is a maximum.

According to the present invention, the focus can be adjusted more easily on an object to be measured whose reflected image has a relatively small contrast.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration diagram of an optical characteristic measuring apparatus according to a first embodiment of the present invention.

FIG. 2 is a diagram illustrating in more detail a configuration for projecting an observation reference image on an object to be measured.

FIG. 3 is a diagram showing an example of an observation image from an object to be measured that is produced by an observation-purpose camera.

FIG. 4 is a block diagram showing a functional configuration of a controller according to the first embodiment of the present invention.

FIG. 5 shows a data structure of an image signal that is output from the observation-purpose camera.

FIGS. 6A and 6B each show an example of a histogram calculated from brightness data.

FIG. 7 is a conceptual diagram of an observation image obtained in the case where an object having a convex spherical surface is to be measured.

FIG. 8 is a diagram showing an example of a characteristic of change of a focus value according to change in distance between an objective lens and an object to be measured.

FIG. 9 is a diagram illustrating a process of searching for a focus position.

FIG. 10 is a flowchart showing a procedure for a focusing process using the optical characteristic measuring apparatus according to the first embodiment of the present invention.

FIG. 11 is a diagram illustrating a process of searching for a spatial reflection point by means of a coordinate method.

FIG. 12 is a flowchart showing a procedure for the process of searching for a spatial reflection point by means of the coordinate method.

FIG. 13 is a diagram illustrating a process of searching for a spatial reflection point by means of a matrix method.

FIG. 14 is a flowchart showing a procedure for the process of searching for a spatial reflection point by means of the matrix method.

FIG. 15 is a schematic configuration diagram of an optical characteristic measuring apparatus according to a second embodiment of the present invention.

### DESCRIPTION OF THE PREFERRED EMBODIMENTS

Embodiments of the present invention will be described in detail with reference to the drawings. In the drawings, like or corresponding components are denoted by like reference characters and a description thereof will not be repeated.

### First Embodiment

### Entire Configuration

An optical characteristic measuring apparatus 100A according to a first embodiment of the present invention is typically a microspectroscopic measuring apparatus, and measures the spectrum of light reflected from an object to be measured (hereinafter also referred to as “object under measurement”), thereby measuring optical characteristics (optical constants) such as (absolute and/or relative) reflectance, refractive index, extinction coefficient, and film thickness of a thin film or the like formed on the object under measurement.

Typical examples of the object under measurement include a device with a thin film formed on any materials such as semiconductor substrate, glass substrate, sapphire substrate, quartz substrate, and film. More specifically, the glass substrate having the thin film formed thereon is used as a display unit of a flat panel display (FPD) such as liquid crystal display (LCD) or plasma display panel (PDP). Further, the sapphire substrate having the thin film formed thereon is used as a nitride semiconductor (GaN: Gallium Nitride)-based LED (Light Emitting Diode) or LD (Laser Diode). Furthermore, the quartz substrate having the thin film formed thereon is used for various optical filters, optical element and projection liquid crystal element for example.

In particular, when optical characteristic measuring apparatus 100A in the present embodiment measures an optical characteristic of an object such as glass substrate that is transparent and has a relatively low reflectance, the optical characteristic measuring apparatus masks a part of an observation light used for focusing so as to project an observation reference image on the object to be measured. Based on a reflected image corresponding to the observation reference image, the apparatus adjusts the focus on the object. Further, optical characteristic measuring apparatus 100A in the present embodiment can also adjust the focus on a mirror-like object to be measured without design (pattern) formed thereon, by masking a part of an observation light used for adjusting the focus.

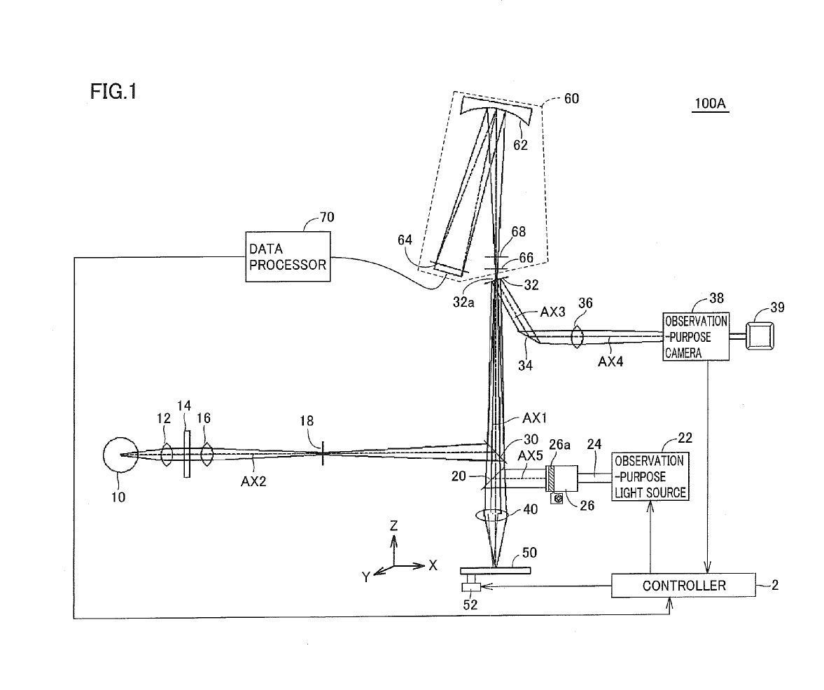

Referring to FIG. 1, optical characteristic measuring apparatus 100A includes a controller 2, a light source 10 used for measurement (hereinafter “measurement-purpose light source”), a collimator lens 12, a cut filter 14, converging lenses 16, 36, a diaphragm 18, beam splitters 20, 30, a light source 22 used for observation (hereinafter “observation-purpose light source”), an optical fiber 24, an emitting portion 26, a pinhole mirror 32, an axis conversion mirror 34, a camera 38 used for observation (hereinafter “observation-purpose camera”), a display 39, an objective lens 40, a stage 50, a moving mechanism 52, a spectroscopic measuring portion 60, and a data processor 70.

Measurement-purpose light source 10 is a light source generating a measurement light used for measuring optical characteristics of an object under measurement, and is typically a deuterium lamp (D₂ lamp) or tungsten lamp or a combination thereof. The measurement light generated by measurement-purpose light source 10 includes a component in a wavelength range for measuring optical characteristics for the object under measurement (250 nm to 750 nm in the case where the object under measurement is a thin film formed on a glass substrate for example). Note that optical characteristic measuring apparatus 100A in the present embodiment does not use the measurement light for focusing purpose. Therefore, the wavelength range of the measurement light can be set to any range. A measurement light including only the components out of the visible band, such as those in the infrared band or ultraviolet band may be used.

Collimator lens 12, cut filter 14, converging lens 16, and diaphragm 18 are arranged on an optical axis AX2 connecting measurement-purpose light source 10 and beam splitter 30, and optically adjust the measurement light emitted from measurement-purpose light source 10.

Collimator lens 12 is an optical element where the measurement light from measurement-purpose light source 10 first enters, and converts the measurement light propagating in the form of diffused rays into parallel rays by refracting the measurement light. The measurement light having passed through collimator lens 12 is applied to cut filter 14.

Cut filter 14 is an optical filter for restricting the wavelength range of the measurement light to the wavelength range necessary for measuring optical characteristics. Specifically, since any wavelength component that is included in the measurement light and that is out of the range for measurement could be a factor of a measurement error, cut filter 14 cuts off any wavelength component out of the range for measurement. Typically, cut filter 14 is formed of a multi-layer film vapor-deposited on a glass substrate or the like.

Converging lens 16 converts the measurement light having passed through cut filter 14 from the parallel rays into converging rays, in order to adjust the beam diameter of the measurement light. The measurement light having passed through converging lens 16 is applied to diaphragm 18.

Diaphragm 18 adjusts the light quantity of the measurement light to an adequate quantity and then applies the light to beam splitter 30. Preferably, diaphragm 18 is disposed at a converging position of the measurement light converted by converging lens 16. The extent to which the light quantity is adjusted by diaphragm 18 is appropriately set according to the depth of field of the measurement light applied to the object under measurement and the necessary light intensity for example.

In contrast, observation-purpose light source 22 is a light source for generating an observation light used for focusing on the object under measurement as well as for checking the position of measurement, and starts or stops generation of the observation light in response to a command from controller 2. The observation light generated by observation-purpose light source 22 is selected such that the observation light includes a component that can be reflected from the object under measurement. In particular, in optical characteristic measuring apparatus 100A in the present embodiment, the observation light is not used for measuring optical characteristics. Therefore, any light source having a wavelength range and a light quantity appropriate for focusing on the object under measurement and for checking the position of measurement can be employed. Observation-purpose light source 22 is connected through optical fiber 24 to emitting portion 26. The observation light generated by observation-purpose light source 22 propagates through optical fiber 24 which is an optical waveguide and is thereafter emitted from emitting portion 26 toward beam splitter 20.

Emitting portion 26 is disposed at a predetermined position on an optical path from observation-purpose light source 22 to beam splitter 20, and includes a mask portion 26a masking a part of the observation light, in order to allow a predetermined observation reference image to be projected on the object under measurement. Specifically, the light intensity (light quantity) at a beam cross section of the observation light immediately after generated by observation-purpose light source 22 is substantially uniform. Mask portion 26a masks (blocks) a part of this observation light, so that the observation light includes a region (shadow region) where the light intensity at a beam cross section is substantially zero. The shadow region is projected as the observation reference image on the object under measurement. The observation reference image is hereinafter also referred to as “reticle image.”

Thus, in optical characteristic measuring apparatus 100A in the present embodiment, the observation light including the reticle image is applied to the object under measurement, so that the focus can be easily adjusted based on the projected reticle image, even when an object under measurement has no design (pattern) formed on its surface (the object is typically a transparent glass substrate). Further, the focus can also be adjusted easily on a mirror-like sample from which the applied light is substantially entirely reflected, since the reticle image allows a reflected image to have a contrast. Here, the reticle image may be in any shape. For example, a reticle image having a concentric or cross-shaped pattern may be used for example.

Stage 50 is a freely movable sample table where the object under measurement is to be disposed, and the surface where the object is disposed is planar-shaped. Stage 50 is driven freely in the three directions (X direction, Y direction, Z direction) by moving mechanism 52 which is mechanically coupled to the stage. Herein, “Z direction” refers to the direction along optical axis AX1, and “X direction” and “Y direction” respectively refer to the two directions independently of each other on a plane orthogonal to optical axis AX1. Moving mechanism 52 is configured for example to include servo motors for three axes and servo drivers for driving the servo motors respectively. Moving mechanism 52 drives stage 50 in response to a stage position command from a controller 2. Stage 50 is thus driven to adjust the positional relation between the object under measurement and objective lens 40 as described hereinlater.

Objective lens 40, beam splitter 20, beam splitter 30, and pinhole mirror 32 are arranged on an optical axis AX1 extending in the direction perpendicular to the planar surface of stage 50.

Beam splitter 30 reflects the measurement light generated by measurement-purpose light source 10 to convert the direction of propagation of the light to the downward direction, as seen in the drawing, along optical axis AX1. Further, beam splitter 30 passes the light which is reflected from the object under measurement and which propagates upward, as seen in the drawing, along optical axis AX1. Typically, beam splitter 30 is formed of a half mirror.

In contrast, beam splitter 20 reflects the observation light generated by observation-purpose light source 22 to convert the direction of propagation of the light to the downward direction along optical axis AX1 as seen in the drawing. At the same time, beam splitter 20 passes the measurement light reflected from beam splitter 30 and propagating downward along optical axis AX1 as seen in the drawing. Namely, beam splitter 20 functions as a light injecting portion injecting the observation light, at a predetermined position on an optical path from measurement-purpose light source 10 to objective lens 40 that constitutes a condensing optical system. The measurement light and the observation light combined at beam splitter 20 enter objective lens 40. Further, beam splitter 20 passes the light reflected from the object under measurement that propagates upward along optical axis AX1 as seen in the drawing. Typically, beam splitter 20 is formed of a half mirror.

Objective lens 40 constitutes a condensing optical system for concentrating the measurement light and observation light propagating downward along optical axis AX1 as seen in the drawing. Specifically, objective lens 40 converges the measurement light and the observation light so that the light converges at the position of the object under measurement or a position close to the object. Further, objective lens 40 is a magnifier lens having a predetermined magnification (for example x10, x20, x30, x40). Therefore, a region subjected to the measurement of the object can be made finer as compared with the beam cross section of the light which is applied to objective lens 40. Thus, optical characteristics of a finer region of the object under measurement can be measured.

The measurement light and the observation light applied from objective lens 40 to the object under measurement are partially reflected from the object under measurement to propagate upward along optical axis AX1 as seen in the drawing. The reflected light passes through objective lens 40 and thereafter passes further through beam splitters 20 and 30 to reach pinhole mirror 32.

Pinhole mirror 32 functions as a light separating portion separating the reflected light generated at the object under measurement into a reflected light for measurement (hereinafter “measurement reflected light”) and a reflected light for observation (hereinafter “observation reflected light”). Specifically, pinhole mirror 32 includes a reflection plane reflecting the reflected light from the object under measurement that propagates upward along optical axis AX1 as seen in the drawing, and an opening (pinhole) 32a is formed having its center where the reflection plane and optical axis AX1 cross each other. Pinhole 32a is formed such that the size of the pinhole is smaller than the beam diameter, at the position of pinhole mirror 32, of the measurement reflected light that is the measurement light from measurement-purpose light source 10 and is reflected by the object under measurement. Further, pinhole 32a is disposed at a position coincident with respective converging positions of the measurement reflected light and the observation reflected light that are respectively the measurement light and the observation light reflected from the object under measurement. This configuration allows a part near optical axis AX1 of the reflected light generated at the object under measured to pass through pinhole 32a and enter spectroscopic measuring portion 60. The remaining part of the reflected light has its direction of propagation converted and accordingly enters axis conversion mirror 34.

Spectroscopic measuring portion 60 measures the spectrum of the measurement reflected light having passed through pinhole mirror 32, and outputs the result of measurement to data processor 70. More specifically, spectroscopic measuring portion 60 includes a diffraction grating 62, a detector 64, a cut filter 66, and a shutter 68.

Cut filter 66, shutter 68 and diffraction grating 62 are arranged on optical axis AX1. Cut filter 66 is an optical filter for limiting wavelength components out of the range for measurement included in the measurement reflected light passing through the pinhole and entering spectroscopic measuring portion 60. In particular, cut filter 66 cuts off any wavelength component out of the range for measurement. Shutter 68 is used for blocking light from entering detector 64 in the case for example where detector 64 is reset. Shutter 68 is typically formed of a mechanical shutter driven by an electromagnetic force.

Diffraction grating 62 separates the applied measurement reflected light into light waves with respective wave lengths and then directs respective light waves to detector 64. Specifically, diffraction grating 62 is a reflective diffraction grating and is configured to reflect diffracted light waves at predetermined wavelength intervals in corresponding directions respectively. When the measurement reflected light is applied to diffraction grating 62 configured as described above, each wavelength component included in the light is reflected in its corresponding direction to enter a corresponding detection region of detector 64. Diffraction grating 62 is typically formed of a flat focus type spherical grating.

Detector 64 outputs an electrical signal according to the light intensity of each wavelength component included in the measurement reflected light separated by diffraction grating 62, in order to measure the spectrum of the measurement reflected light. Detector 64 is typically formed of a photodiode array including detecting elements such as photodiodes arranged in an array or a matrix-arranged CCD (Charged Coupled Device).

Diffraction grating 62 and detector 64 are appropriately designed according to the wavelength range for measurement of optical characteristics and the wavelength intervals for measurement thereof, for example.

Data processor 70 performs various data processing operations (typically fitting, noise removal) based on the result of measurement (electrical signal) from detector 64, and outputs optical characteristics (optical constants) of the object under measurement such as reflectance, refractive index, extinction coefficient, and film thickness, to controller 2 or another apparatus (not shown).

In contrast, the observation reflected light that is reflected by pinhole mirror 32 propagates along an optical axis AX3 and enters axis conversion mirror 34. Axis conversion mirror 34 converts the direction in which the observation reflected light propagates, from the direction of optical axis AX3 to the direction of an optical axis AX4. Thus, the observation reflected light propagates along optical axis AX4 and enters observation-purpose camera 38.

Observation-purpose camera 38 is an image pickup receiving the observation reflected light and outputting an image signal according to the received observation reflected image, and is typically formed of a CCD (Charged Coupled Device) or CMOS (Complementary Metal Oxide Semiconductor) sensor for example. Observation-purpose camera 38 is configured to be sensitive to a wavelength component included in the observation light, and typically has its sensitivity to the visible band. Observation-purpose camera 38 outputs to display 39 and controller 2 an image signal according to the received observation reflected light. Display 39 shows the image of the observation reflected light based on the image signal from observation-purpose camera 38. A user sees the image shown on display 39 to check the position for measurement for example. Display 39 is typically formed of a liquid crystal display (LCD) for example.

Controller 2 determines a focus state of the measurement light on the object under measurement, based on the reflected image which is included in the observation reflected light and which corresponds to the reticle image, according to the image signal from observation-purpose camera 38, and drives moving mechanism 52 according to the result of the determination of the focus state. As described above, both of the measurement light and the observation light are applied through objective lens 40 to the object under measurement. Therefore, the optical path from measurement-purpose light source 10 to objective lens 40 and the optical path from observation-purpose light source 22 to objective lens 40 are designed such that these optical paths are optically equivalent to each other. Thus, the focus state of the observation light on the object under measurement and the focus state of the measurement light on the object under measurement can be regarded as substantially identical to each other. In other words, if the observation light is focused on the object under measurement, the measurement light can also be regarded as focused on the object. Accordingly, optical characteristic measuring apparatus 100A in the present embodiment determines the focus state of the measurement light on the object under measurement, based on the focus state of the reflected image produced from the observation reflected light which is generated by the observation light reflected from the object under measurement.

More specifically, controller 2 calculates a value indicative of the focus state of the measurement light on the object under measurement (hereinafter also referred to as “focus value”) based on the image signal from observation-purpose camera 38, and controls the positional relation between the object under measurement and objective lens 40 such that the focus value is a maximum. As to how the focus value is calculated and how the positional relation is controlled for example, a description will be given hereinlater.

Further, controller 2 obtains, for a plurality of coordinates on the XY plane, respective focus positions Mz each corresponding to the position in the Z direction and each being the position of the object under measurement (stage 50) at which the focus value is a maximum value. Based on a plurality of focus positions Mz thus obtained, controller 2 searches for a spatial inflection point(s) of the object under measurement. “Spatial inflection point” herein refers to a point, in the case where the object under measurement has a surface shape such as convex or concave shape, at which the direction of spatial variation changes, such as the uppermost or lowermost point of the convex or concave surface. More specifically, in the case where the object under measurement is a convex-shaped lens for example, controller 2 determines that the uppermost point of the lens is “spatial inflection point.” An operation of this search for any spatial inflection point(s) will also be described hereinlater.

Controller 2 is typically formed of a computer including a CPU (Central Processing Unit), a RAM (Random Access Memory) and a hard disk apparatus (these components are not shown), and the process of the present invention is implemented by reading a program stored in advance in the hard disk apparatus onto the RAM and executing the program by the CPU. A part or the whole of the process of the present invention may be implemented by hardware.

Regarding the correspondence between FIG. 1 and the present invention, measurement-purpose light source 10 corresponds to “measurement-purpose light source,” observation-purpose light source 22 corresponds to “observation-purpose light source,” objective lens 40 corresponds to “condensing optical system,” beam splitter 20 corresponds to “light injecting portion,” mask portion 26a corresponds to “mask portion,” pinhole mirror 32 corresponds to “light separating portion,” observation-purpose camera 38 corresponds to “output portion,” moving mechanism 52 corresponds to “adjusting mechanism,” and observation-purpose camera 38 corresponds to “image pickup.”

Observation Reference Image

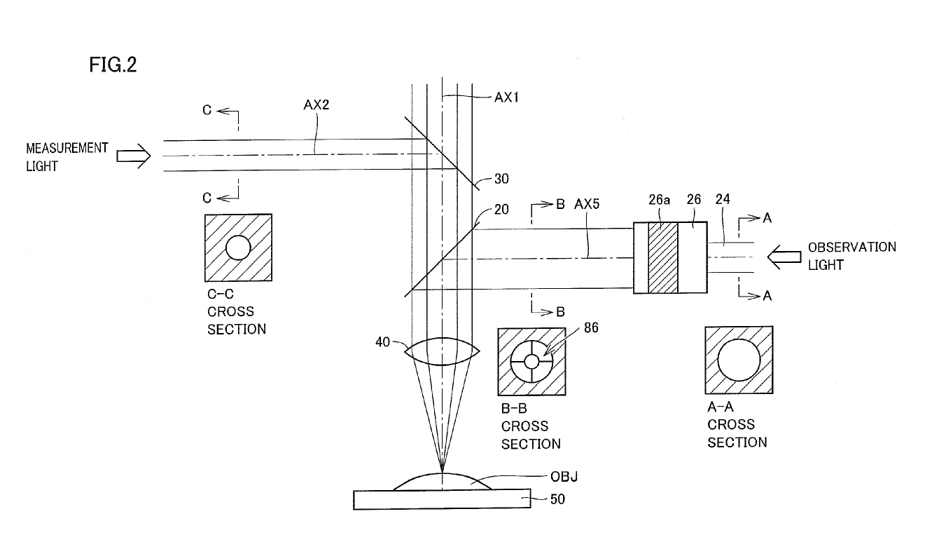

FIG. 2 is a diagram illustrating in more detail a configuration for projecting an observation reference image on an object under measurement.

Referring to FIG. 2, an observation light generated by observation-purpose light source 22 (FIG. 1) is directed through optical fiber 24 to emitting portion 26. The light intensity (light quantity) at a beam cross section (typically circular) of the observation light generated by observation-purpose light source 22 is substantially uniform as shown by the A-A cross section. Then, mask portion 26a included in emitting portion 26 masks a part of the observation light so that the light intensity of a region corresponding to a reticle image at a beam cross section is substantially zero. Namely, the light intensity at a beam cross section (circular) of the observation light after passing through emitting portion 26 has a shadow region corresponding to the reticle image as shown by the B-B cross section. The observation light including the shadow region corresponding to the reticle image is reflected from beam splitter 20 and propagates along optical axis AX1 toward object under measurement OBJ.

In contrast, the measurement light generated by measurement-purpose light source 10 (FIG. 1) is reflected by beam splitter 30 and propagates along optical axis AX1 toward object under measurement OBJ. Here, the light intensity (light quantity) at a beam cross section (circular) of the measurement light is substantially uniform as shown by the C-C cross section.

In this way, object under measurement OBJ is irradiated with the measurement light and the observation light.

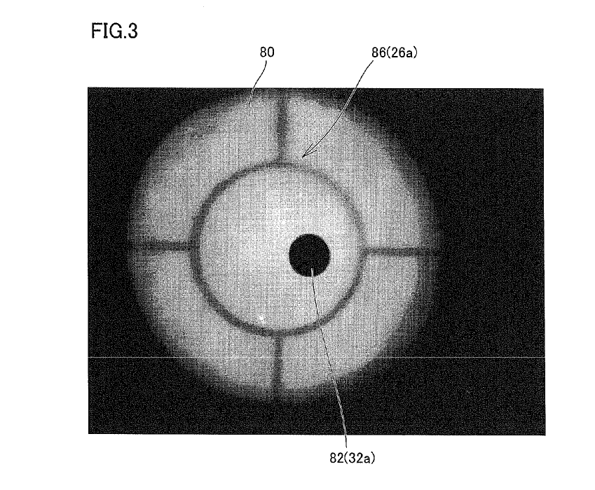

FIG. 3 is a diagram showing an example of an observation image from object under measurement OBJ as produced by observation-purpose camera 38.

Referring to FIG. 3, observation-purpose camera 38 provides an observation field 80 according to the beam diameter of the observation light applied to object under measurement OBJ. In observation field 80, a reflected image from object under measurement OBJ as well as a reflected image 86 corresponding to a reticle image projected on object under measurement OBJ are present. At a central portion of observation field 80, a shadow portion 82 due to the presence of pinhole 32a provided in pinhole mirror 32 (FIG. 1) is present. Namely, shadow portion 82 is generated as a result of separating the measurement reflected light that is the measurement light reflected from object under measurement OBJ.

Optical characteristic measuring apparatus 100A in the present embodiment determines a focus state of the measurement light on object under measurement OBJ, based on the contrast (difference between light and dark parts) of reflected image 86 corresponding to the reticle image as shown in FIG. 3.

In most cases, the observation light is set to include a component in the visible band. However, in the case where the reflectance of the object under measurement in the visible band is extremely low (such as visible antireflection coating or the like), the observation light may be set to include a component in the near-infrared or ultraviolet band. In this case, the light-receiving sensitivity of observation-purpose camera 38 is also selected to be appropriate for the wavelength of the observation light.

Beam Diameter of Measurement Light and Observation Light

In the case where the object under measurement is a convex-shaped lens or the like, the measurement light is applied to the spherical surface. Therefore, if the beam diameter of the measurement light (diameter of an illuminated spot) is larger than the radius of curvature or the like of the object under measurement, the measurement light is dispersed at the surface of the object under measurement and consequently a large part of the measurement light is reflected to a path different from the incident path. Namely, since the quantity of light regularly reflected from the object under measurement is smaller and thus optical characteristics such as reflectance and film thickness cannot be measured accurately.

Therefore, in terms of further improving the precision in measurement of optical characteristics, it is preferable that the beam diameter of the measurement light applied to the object under measurement is relatively small. By way of example, the relation between the beam diameter of the measurement light applied to the object under measurement and the size of the object is preferably that the beam diameter of the measurement light is approximately 0.01 mm in the case where the object under measurement is a lens of 3 to 7 mm in diameter.

While the measurement light propagates, slight reflection occurs at a surface of a lens on the optical path, and/or the measurement reflected light converges at a position displaced from pinhole 32a. The light that is undesirable to spectroscopic measuring portion 60 (or undesirable to enter spectroscopic measuring portion 20) is also referred to as internal reflected light and may be a factor of a measurement error. The beam diameter of the propagating measurement light can be made smaller to reduce such internal reflected light entering pinhole 32a. For example, if the beam diameter of the measurement light is decreased to one-eighth, the internal reflected light can be reduced to approximately one-sixtyfourth, as simply calculated. Moreover, influences of uneven reflection and irregular reflection can be reduced, so that actually the internal reflected light can be further reduced.

In contrast, in terms of further facilitating focusing on the object under measurement, it is desirable that the beam diameter of the observation light applied on the object under measurement is relatively large. This is for the purpose of keeping an observation field as large as possible.

Accordingly, optical characteristic measuring apparatus 100A in the present embodiment is designed such that the beam diameter of the measurement light at beam splitter 20 is smaller than the beam diameter of the observation light at beam splitter 20 as shown in FIG. 2.

Process in Controller

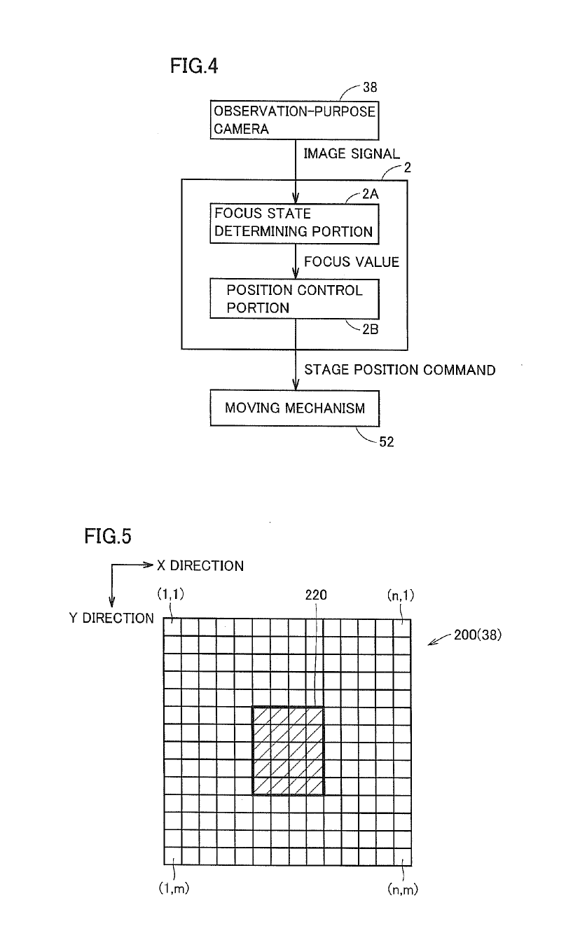

FIG. 4 is a block diagram showing a functional configuration of controller 2 in the first embodiment of the present invention.

Referring to FIG. 4, controller 2 includes, as its functions, a focus state determining portion 2A and a position control portion 2B.

Focus state determining portion 2A determines a focus state of the measurement light on the object under measurement, based on a reflected image which corresponds to a reticle image and is included in the observation reflected light generated by reflection of the observation light from the object under measurement. More specifically, based on an image signal according to the observation reflected light from observation-purpose camera 38, a focus value (hereinafter also referred to as FV) is calculated, and the FV is output to position control portion 2B. Here, focus state determining portion 2A can also calculate the focus value based on a signal component corresponding to a pre-set partial region and included in the image signal from observation-purpose camera 38.

Position control portion 2B outputs a stage position command according to the focus value from focus state determining portion 2A to drive moving mechanism 52 and thereby adjust the positional relation between objective lens 40 (FIGS. 1 and 2) and the object under measurement. Specifically, position control portion 2B adjusts the distance between objective lens 40 and the object under measurement along optical axis AX1 such that the focus value is a maximum.

Regarding the correspondence between above-described FIG. 4 and the present invention, focus state determining portion 2A corresponds to “focus state determining portion” and position control portion 2B corresponds to “position control portion.”

Process of Calculating Focus Value

FIG. 5 is a diagram showing a data structure of the image signal which is output from observation-purpose camera 38.

Referring to FIG. 5, observation-purpose camera 38 produces a reflected image showing stage 50 as observed from observation-purpose light source 22 along optical axis AX1. Namely, observation-purpose camera 38 outputs the image signal indicating the reflected image corresponding to the X direction and the Y direction on stage 50. This image signal includes a frame 200 that is updated in every image-producing cycles. Here, in FIG. 5, the row direction of frame 200 corresponds to the X direction on stage 50 and the column direction of frame 200 corresponds to the Y direction on stage 50 for convenience of description. The correspondence in direction, however, is not limited to the above-described one.

Frame 200 is constituted of brightness data in m rows×n columns corresponding respectively to a plurality of pixels arranged in a matrix. The brightness data corresponding to each pixel typically has any level of 0 to 255 as a contrast value if observation-purpose camera 38 is a monochrome camera, and typically has any level of 0 to 255 for each of typically red (R), green (G) and blue (B) if observation-purpose camera 38 is a color camera.

Focus state determining portion 2A calculates a histogram for the brightness data of each pixel, and determines the focus value based on the histogram.

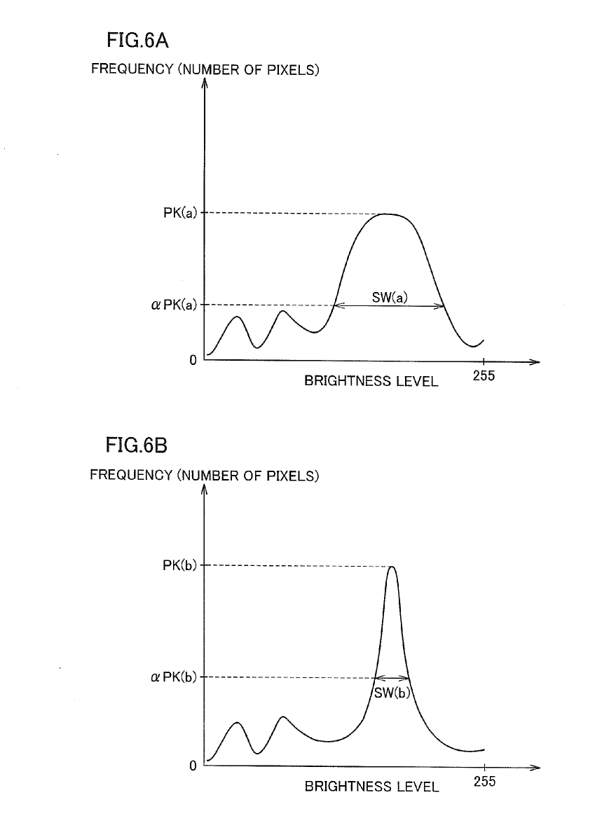

FIGS. 6A and 6B are each a diagram showing an example of the histogram calculated from the brightness data.

FIG. 6A shows a histogram in an unfocused state, and FIG. 6B shows a histogram in a focused state.

As shown in FIGS. 6A and 6B, the histogram shows a state of distribution of the brightness levels for the pixels constituting frame 200, and the numbers of pixels having respective brightness levels are plotted in association with the brightness level each. The histograms shown in FIGS. 6A and 6B are based on the brightness level in one dimension. In the case where each pixel has the three-dimensional brightness levels for red (R), green (G) and blue (B), the histogram can be calculated using the brightness level for a particular one of the colors that are red (R), green (G) and blue (B), or using a value representing the sum of respective brightness levels of red (R), green (G) and blue (B). Further, instead of or in addition to the histogram based on the brightness level of each pixel, a histogram may be calculated based on the difference between respective brightness levels of pixels adjacent to each other in the row or column direction.

On the histogram thus calculated, a different feature is shown depending on the focus state. Typically, if the measurement light (observation light) is not focused on the object under measurement, the calculated histogram shows a relatively gentle peak (FIG. 6A). In contrast, if the measurement light (observation light) is focused on the object under measurement, the calculated histogram shows a relatively sharp peak (FIG. 6B). Accordingly, focus state determining portion 2A calculates the focus value based on such a difference of the feature shown by the histogram.

Typically, focus state determining portion 2A calculates the focus value based on the degree of extension of the peak shown on the histogram. More specifically, focus state determining portion 2A calculates histograms of the brightness data to obtain respective peak values PK (a) and PK (b). Then, focus state determining portion 2A obtains respective widths SW (a) and SW (b) of the histograms corresponding to respective values (α PK (a), α PK (b)) determined by multiplying the obtained peak value by a predetermined reduction factor α. Based on the widths SW (a), SW (b) of the histograms, focus state determining portion 2A determines the focus value. Namely, as width SW of the histogram is smaller, the focus value is larger.

In the process of calculating the focus value as described above, the brightness data for all pixels included in frame 200 may be used. However, depending on the shape of the object under measurement, it is preferable to use only the brightness data for pixels corresponding to a partial area set in advance, of the pixels included in frame 200.

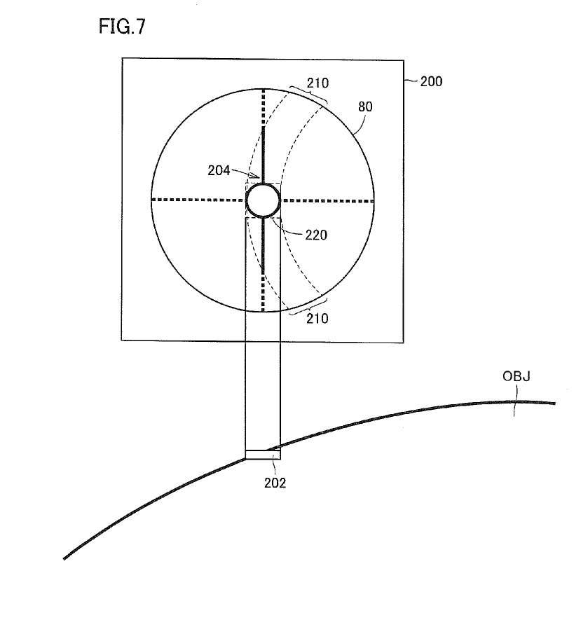

FIG. 7 is a conceptual diagram of an observation image obtained in the case where an object having a convex spherical surface is to be measured.

Referring to FIG. 7, the distance between objective lens 40 and each point on the surface of object under measurement OBJ with the convex-shaped spherical surface such as lens varies according to the shape of the surface. Here, in the case where objective lens 40 is formed of a magnifier lens having a predetermined magnification, the depth of focus is extremely small (approximately a few tens of μm for example). Therefore, in some cases, only a predetermined area of the observation image produced by observation-purpose camera can be in the focused state.

For example, in the case where object under measurement OBJ has a spherical shape, bounds 210 (a region 202 in a cross section) having its position in the Z direction within a predetermined range (namely within the depth of focus) in observation field 80 included in frame 200 may be in a focused state. Therefore, of a projected reticle image 204, an area (indicated by the solid line in FIG. 7) corresponding to bounds 210 can be clearly observed. However, the area (indicated by the broken line in FIG. 7) other than the area corresponding to bounds 210 is observed in a blurred state.

Therefore, in the case where the area on which the focus can be adjusted is smaller as compared with observation field 80 of frame 200, it is preferable to calculate the focus value using the brightness data for pixels corresponding to an area on which the focus is to be adjusted. Namely, it is preferable to calculate the focus value based on a signal component which corresponds to a pre-set area 220 and which is included in the image signal according to the observation reflected light output from observation-purpose camera 38. As described above, the design is made such that the spot illuminated with the measurement light (namely the beam diameter of the measurement light) is smaller as compared with observation field 80 (namely the beam diameter of the observation light). Therefore, for calculating the focus value, it is more preferable to use pixels corresponding to an area illuminated with the measurement light, of the pixels included in frame 200, or to use pixels corresponding to an area covering the above-described area.

Referring to FIG. 5, by way of example, focus state determining portion 2A extracts, from pixels constituting frame 200 of the image signal which is output from observation-purpose camera 38, pixels included in area 220 on which the focus is to be adjusted, and calculates the focus value based on the brightness data of the extracted pixel.

As for the process of calculating the focus value, any known method other than the above-describe method may be used.

Process of Focusing

As described above, according to the focus value calculated by focus state determining portion 2A, position control portion 2B adjusts the distance between objective lens 40 and the object under measurement along optical axis AX1, namely adjusts the focus of the measurement light (observation light) on the object under measurement.

Specifically, position control portion 2B successively changes the distance between objective lens 40 and the object under measurement along optical axis AX1 (namely changes the position in the Z direction), successively obtains the focus value calculated for each position as changed, and searches for the position in the Z direction at which the maximum focus value is obtained.

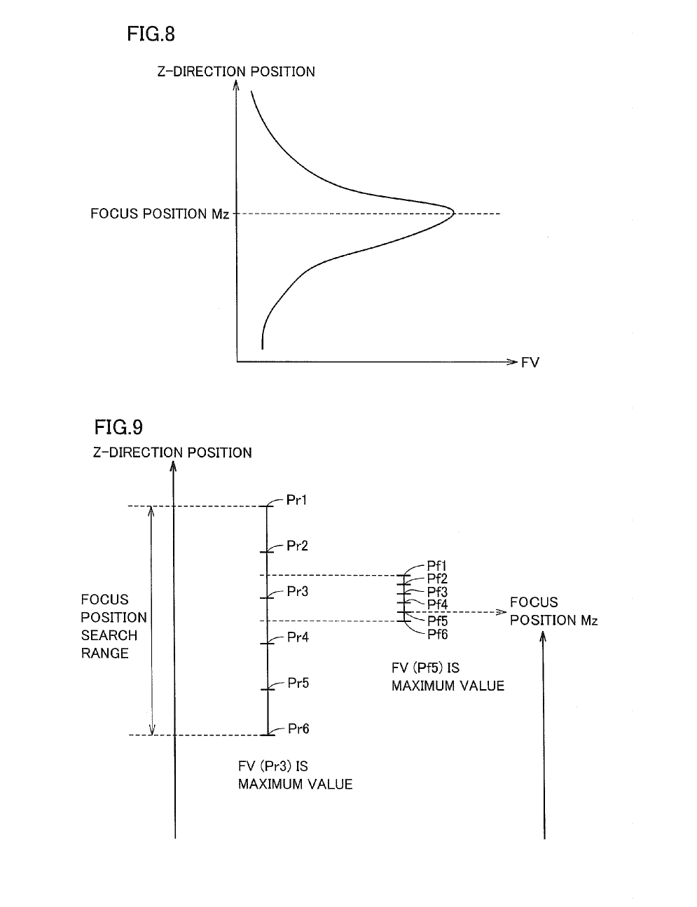

FIG. 8 is a diagram showing an example of a characteristic of the change of focus value FV according to a change in distance between objective lens 40 and the object under measurement.

Referring to FIG. 8, position control portion 2B gives the stage position command to moving mechanism 52 to change the distance between objective lens 40 and the object under measurement along optical axis AX1. Accordingly, focus value FV calculated by focus state determining portion 2A increases as the position approaches focus position Mz. In the state where the position coincides with the position at which the measurement light (observation light) is focused on the object under measurement, namely in the state where the position of the object under measurement coincides with the converging position where the measurement light (observation light) is concentrated by objective lens 40, focus value FV has a maximum value.

Utilizing this characteristic, position control portion 2B searches for the position in the Z-axis direction at which the focus value is a maximum, for focusing the measurement light (observation light). Here, focus position Mz typically refers to the distance from a reference position in the Z direction.

Here, the minimum interval between the positions in the Z direction at which the respective focus value FVs are calculated can be made relatively small (hereinafter also referred to as focus resolution). Therefore, if focus position Mz is searched for by the unit (interval) of the focus resolution, the amount of calculation will be significantly large depending on the extent of the range to be searched. Therefore, it is preferable to make a rough adjustment by an interval in the Z direction larger than the focus resolution (hereinafter also referred to as focus search resolution), and thereafter make a fine adjustment by the unit of the focus resolution. Here, preferably the focus search resolution is an integral multiple of the focus resolution.

FIG. 9 is a diagram illustrating a process of searching for the focus position.

Referring to FIG. 9, it is supposed that a predetermined range in which the focus position is searched for in the Z direction is defined in advance according to the range in which stage 50 can be moved and the height of the object under measurement, for example. First, position control portion 2B moves the object under measurement in the Z direction by the unit of the focus search resolution for making a rough adjustment. In the example shown in FIG. 9, position control portion 2B successively moves the object under measurement (stage 50) in the Z direction to the six positions Pr1 to Pr6. Then, position control portion 2B obtains focus values FV (Pr1) to FV (Pr6) calculated for respective positions Pr1 to Pr6 in the Z direction by focus state determining portion 2A. After this, the maximum one of the obtained focus values FV (Pr1) to FV (Pr6) is extracted. The example shown in FIG. 9 illustrates the case where focus value FV (Pr3) at Z-direction position Pr3 is the maximum value.

After the rough adjustment is completed in this way, position control portion 2B makes a fine adjustment. Specifically, position control portion 2B moves the object under measurement in the Z direction by the unit of the focus resolution, in the range of the focus search resolution in which the center is located at the Z-direction position Pr3 where the maximum focus value is obtained. Regarding the example shown in FIG. 9, it is supposed that the focus search resolution is set to be six times as large as the focus resolution. In this case, position control portion 2B successively moves the object under measurement (stage 50) in the six Z-direction positions Pf1 to Pf6. Then, position control portion 2B obtains focus values FV (Pf1) to FV (Pf6) for respective Z-direction positions Pf1 to Pf6 that are calculated by focus state determining portion 2A. After this, the maximum focus value is extracted from obtained focus values FV (Pf1) to FV (Pf). The example shown in FIG. 9 illustrates the case where focus value FV (Pf5) at Z-direction position Pf5 is the maximum focus value. Accordingly, position control portion 2B determines that Z-direction position Pf5 at which the maximum focus value is obtained is focus position Mz.

In this way, focus position Mz is searched for in the two steps, namely the rough adjustment and the fine adjustment, and thus the number of the series of operations of moving the object under measurement and calculating the focus value can be reduced. Regarding the example shown in FIG. 9, 36 operations are necessary in the case where the focus position is searched for with only the fine adjustment in the range where the focus position is searched for. However, only 12 operations may be performed in the case where focus position Mz is searched for in the two steps of the rough adjustment and the fine adjustment. Thus, the time to be consumed for searching for focus position Mz can be reduced to one-third as simply calculated.

In the above-described example, the configuration for searching for the focus position in the two steps is illustrated. The range to be searched for (search resolution) may be divided into a larger number of units to more efficiently search for the focus position.

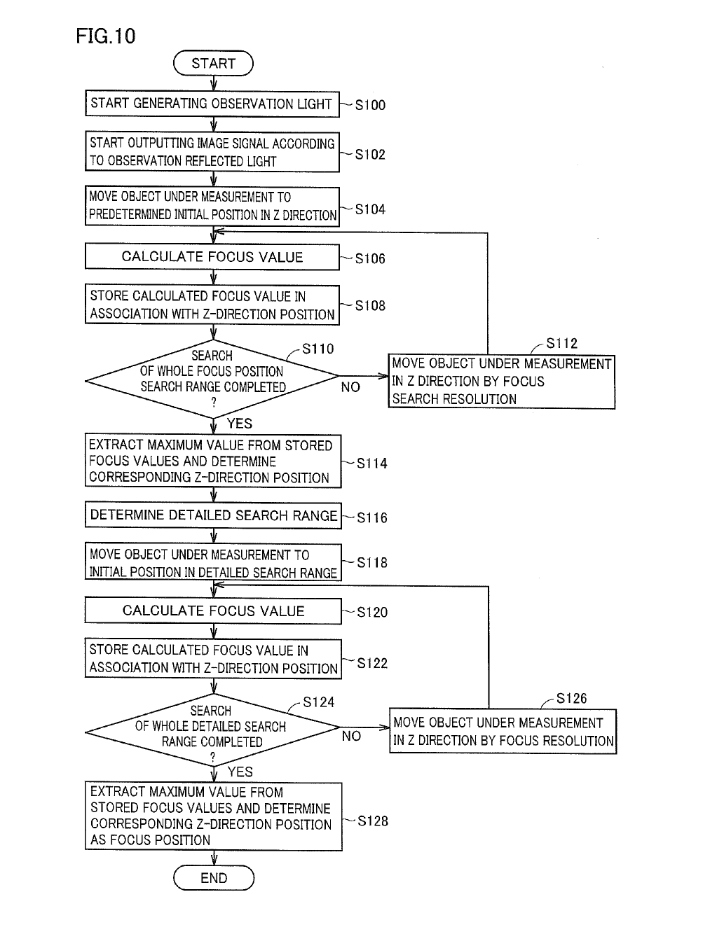

FIG. 10 is a flowchart showing a procedure for the focusing process using optical characteristic measuring apparatus 100A in the first embodiment of the present invention.

Referring to FIG. 10, in response to operation by a user for example, observation-purpose light source 22 starts generating the observation light (step S100). The generated observation light is applied through objective lens 40 to the object under measurement. Then, the observation reflected light generated at the object under measurement is applied through pinhole mirror 32 for example to observation-purpose camera 38. Receiving the observation reflected light, observation-purpose camera 38 starts outputting to controller 2 an image signal according to the observation reflected light (step S102).

Position control portion 2B of controller 2 moves the object under measurement (stage 50) to an initial position in the Z direction that is determined in advance (step S104). Then, based on the image signal from observation-purpose camera 38, focus state determining portion 2A of controller 2 calculates the focus value (step S106), and position control portion 2B of controller 2 stores the calculated focus value in association with the position in the Z direction at this time (step S108).

After this, position control portion 2B of controller 2 determines whether or not the search of the whole of a predetermined focus position search range is completed (step S110). When the search of the whole of the focus position search range is not completed (NO in step S110), position control portion 2B of controller 2 further moves the object under measurement (stage 50) in the Z direction by the focus search resolution (step S112), and the operations from step S106 are performed again.

When the search of the whole of the predetermined focus position search range is completed (YES in step S110), position control portion 2B of controller 2 extracts the maximum focus value from focus values stored in step S108 as described above, and determines the Z-direction position corresponding to the maximum value (step S114). The operations in above-described steps S104 to S114 correspond to the above-described rough adjustment.

Then, position control portion 2B of controller 2 determines that the range of the focus search resolution whose center is the Z-direction position determined in step S114 is a range of detailed search (step S116). Position control portion 2B of controller 2 moves the object under measurement (stage 50) to an initial position in the range of detailed search (step S118). Focus state determining portion 2A of controller 2 calculates the focus value based on the image signal from observation-purpose camera 38 (step S120), and position control portion 2B of controller 2 stores the calculated focus value in association with the Z-direction position at this time (step S122).

After this, position control portion 2B of controller 2 determines whether or not the search of the whole of the detailed search range is completed (step S124). When the search of the whole of the detailed search range is not completed (NO in step S124), position control portion 2B of controller 2 further moves the object under measurement (stage 50) by the focus resolution in the Z direction (step S126), and operations from step S120 are performed again.

When the search of the whole of the detailed search range is completed (YES in step S124), position control portion 2B of controller 2 extracts the maximum focus value from the focus values stored in step S122, determines that the Z-direction position corresponding to the maximum value is the focus position (step S128), and ends the focusing process. The operations in above-described steps S116 to S128 correspond to the above-described fine adjustment.

Through the process procedure as described above, the focus position is determined.

Process of Searching for Spatial Inflection Point

Position control portion 2B of controller 2 may perform, in addition to the focusing process as described above, a process of searching for a spatial reflection point of the object under measurement. For example, in the case where the object under measurement is a convex-shaped hemispherical object such as lens, a measurement error increases due to irregular reflection which occurs when the measurement light is applied to an inclined surface (side surface) other than the topmost point. Therefore, preferably the measurement light is applied to a region around the topmost point. However, since the search for the topmost point with the eyes of the user requires considerable time and effort, the search is preferably automated. Accordingly, optical characteristic measuring apparatus 100A in the present embodiment uses any of methods (1) to (3) described below to search for a spatial reflection point of the object under measurement.

(1) Coordinate Method

The coordinate method is applied to an object under measurement having only one spatial reflection point such as convex or concave object (typically a lens).

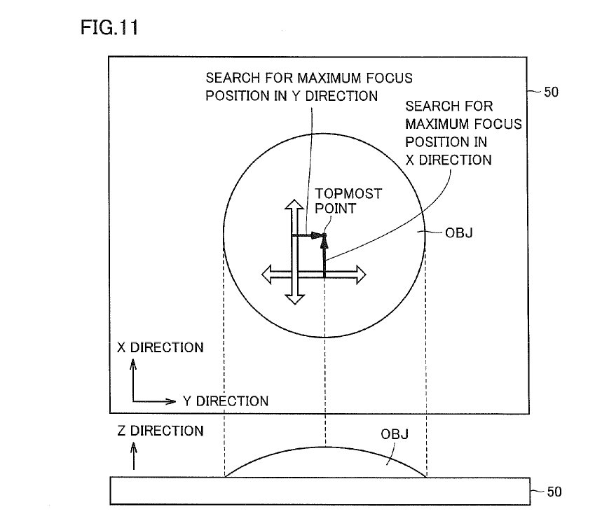

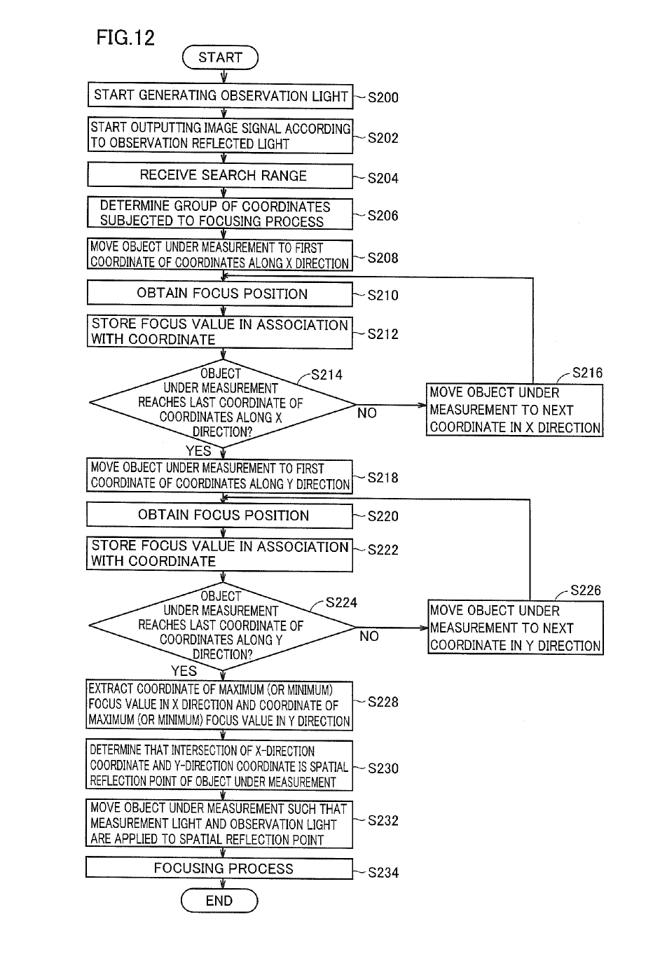

FIG. 11 is a diagram illustrating the process of searching for a spatial reflection point by means of the coordinate method.

Referring to FIG. 11, a description will be given of the case where position control portion 2B searches for the topmost point of a convex-shaped object under measurement OBJ. First, position control portion 2B performs the above-described focusing process for each of a plurality of coordinates along the X direction on stage 50 to obtain focus position Mz at each coordinate. When the process of obtaining focus position Mz in the X direction is completed, position control portion 2B performs the above-described focusing operation for each of a plurality of coordinates in the Y direction to obtain focus position Mz at each coordinate.

Position control portion 2B thereafter extracts a coordinate in the X direction at which focus position Mz has the maximum value and a coordinate in the Y direction at which focus position Mz has the maximum value. Then, position control portion 2B determines that the point of intersection of the extracted X-direction coordinate and the extracted Y-direction coordinate is the topmost point (namely spatial reflection point) of object under measurement OBJ.

Likewise, in the case where the bottommost point of a concave-shaped object under measurement OBJ is searched for, the focusing process is performed for each of a plurality of coordinates along the X direction and the Y direction each, and thereafter position control portion 2B extracts a coordinate in the X direction at which focus position Mz has the minimum value and a coordinate in the Y direction at which focus position Mz has the minimum value. Then, position control portion 2B determines that the point of intersection of the extracted X-direction coordinate and the extracted Y-direction coordinate is the bottommost point (namely spatial reflection point).

After the spatial reflection point is thus searched for, position control portion 2B moves object under measurement OBJ along the XY plane for allowing the spatial reflection point to be irradiated with the measurement light and the observation light in order to measure an optical characteristic at the reflection point, and further performs the focusing process.

While the coordinate method requires that the object under measurement is convex or concave in shape, it is advantageous that the spatial reflection point can be surely searched for even when the number of operations for search (the number of operations for obtaining the focus position) is small.

FIG. 12 is a flowchart showing a procedure for the process of searching for a spatial reflection point by means of the coordinate method.

Referring to FIG. 12, in response to operation by a user for example, observation-purpose light source 22 starts generating the observation light (step S200). The generated observation light is applied through objective lens 40 to the object under measurement. Then, the observation reflected light generated at the object under measurement is applied through pinhole mirror 32 for example to observation-purpose camera 38. Receiving the observation reflected light, observation-purpose camera 38 starts outputting to controller 2 an image signal according to the observation reflected light (step S202).

Position control portion 2B of controller 2 receives a search range for a spatial reflection point (step S204), and determines a group of coordinates in each of the X direction and Y direction for which the focusing process is to be performed (step S206). Position control portion 2B of controller 2 then successively performs the focusing process at each coordinate in the X direction and Y direction.

Position control portion 2B of controller 2 moves the object under measurement (stage 50) such that the observation light is applied to the first coordinate in the X direction (step S208), and performs the focusing process to obtain focus position Mz (step S210). Position control portion 2B of controller 2 associates the obtained focus value with the coordinate and stores them (step S212). At this time, although the coordinate in the Y direction may be set to any coordinate, it is preferable to move the object in advance to a reference coordinate in the Y direction (the first coordinate of the coordinates along the Y direction for example).

Subsequently, position control portion 2B of controller 2 determines whether or not the object under measurement (stage 50) reaches the last coordinate of the coordinates along the X direction (step S214). When the object under measurement (stage 50) does not reach the last coordinate (NO in step S214), position control portion 2B of controller 2 further moves the object under measurement (stage 50) such that the following coordinate in the X direction is irradiated with the observation light (step S216), and the operations from step S210 are performed again.

When the object under measurement (stage 50) reaches the last coordinate (YES in step S214), position control portion 2B of controller 2 moves the object under measurement (stage 50) such that the first coordinate of the coordinates along the Y direction is irradiated with the observation light (step S218), and performs the focusing process to obtain focus position Mz (step S220). Then, position control portion 2B of controller 2 associates the obtained focus value with the coordinate and stores them (step S222). At this time, although the coordinate in the X direction may be set to any coordinate, it is preferable to move in advance the object to a reference coordinate in the X direction (the first coordinate of the coordinates along the X direction for example).

After this, position control portion 2B of controller 2 determines whether or not the object under measurement (stage 50) reaches the last coordinate of the coordinates along the Y direction (step S224). When the object under measurement (stage 50) does not reach the last coordinate (NO in step S224), position control portion 2B of controller 2 further moves the object under measurement (stage 50) such that the following coordinate in the Y direction is irradiated with the observation light (step S226), and the operation from step S220 are performed again.

When the object under measurement (stage 50) reaches the last coordinate (YES in step S224), position control portion 2B extracts a coordinate in the X direction at which focus position Mz has the maximum value (or minimum value) as well as a coordinate in the Y direction at which focus position Mz has the maximum value (or minimum value) (step S228). Then, position control portion 2B determines that the point of intersection of the X-direction coordinate and the Y-direction coordinate extracted in step S228 is the spatial reflection point of object under measurement OBJ (step S230).

Further, position control portion 2B moves the object under measurement along the XY plane such that the spatial reflection point determined in step S230 is irradiated with the measurement light and the observation light (step S232), and further performs the focusing process (step S234).

The above-described process procedure is used to search for the spatial reflection point of the object under measurement.

(2) Matrix Method

According to the matrix method, a search region including a reflection point is set in advance, focus position Mz at predetermined intervals in the search region is obtained, and an approximate function for focus position Mz is calculated so as to determine the spatial reflection point.

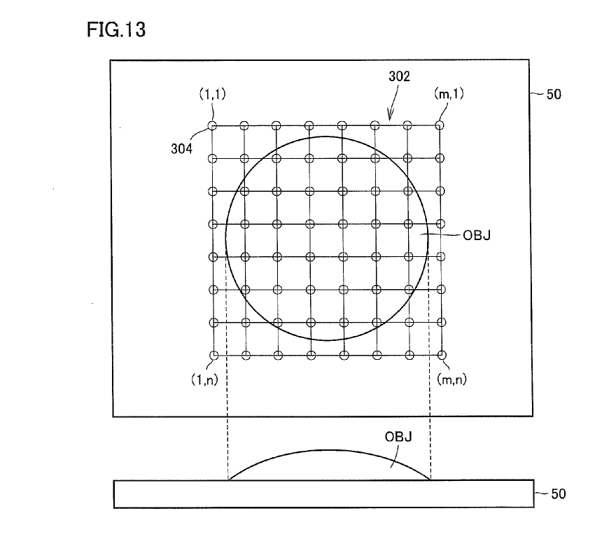

FIG. 13 is a diagram illustrating a process of searching for a spatial reflection point by means of the matrix method.

Referring to FIG. 13, position control portion 2B first sets a search range 302 on the XY plane on stage 50. Search range 302 may be set in advance by a user. Then, position control portion 2B sets a plurality of search points 304 at predetermined intervals in search range 302. Specifically, position control portion 2B defines a mesh on search range 302 and sets search point 304 at each point of intersection in the mesh.

FIG. 13 shows the case where search points 304 in m rows×n columns ((1, 1) to (m, n)) are set.

Then, position control portion 2B successively performs the above-described focusing process for each of search points 304, and obtains focus position Mz at each search point 304. After this, based on focus position Mz at each search point 304, position control portion 2B determines an approximate function using a two-dimensional spline method or the like. Specifically, supposing that the focus position at coordinates (x, y) is expressed as Mz (x, y), position control portion 2B determines approximate function Fa (Mz: x, y) such that the residuals from Mz (1, 1) to Mz (m, n) are minimums, and determine that the coordinates corresponding to the reflection point for variable x and variable y of this approximate function Fa (Mz: x, y) are the spatial point of reflection.

After the spatial reflection point is searched for as described above, in order to measure an optical characteristic at this reflection point, position control portion 2B moves object under measurement OBJ along the XY plane such that the spatial reflection point is irradiated with the measurement light and the observation light, and thereafter further performs the focusing process.

While the matrix method requires a relatively large number of search points and thus requires a certain time, the number of spatial reflection points included in object under measurement OBJ is unlimited. Namely, even in the case where object under measurement OBJ includes a plurality of reflection points, the reflection points can be searched for.

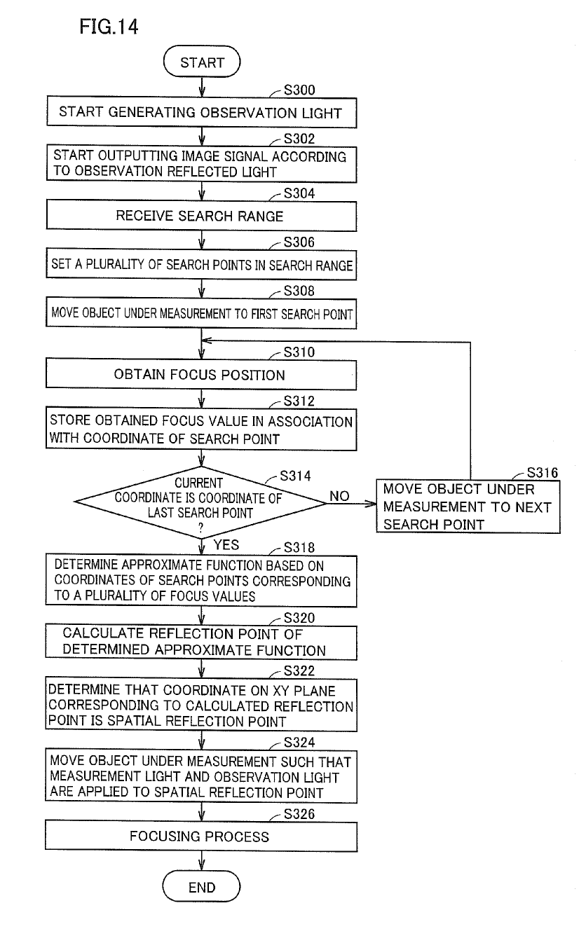

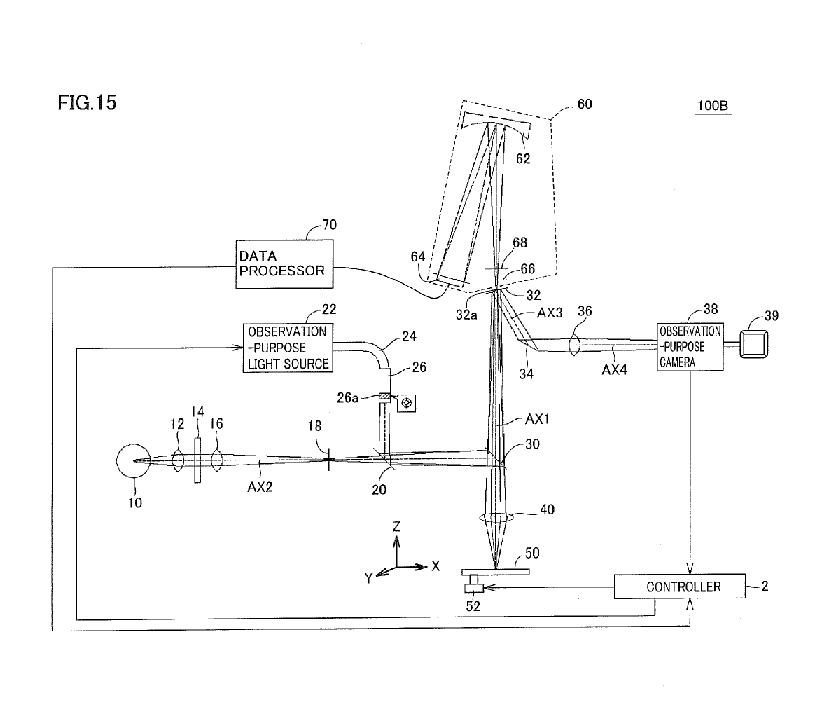

FIG. 14 is a flowchart showing a procedure for the process of searching for a spatial reflection point by means of the matrix method.

Referring to FIG. 14, in response to operation by a user for example, observation-purpose light source 22 starts generating the observation light (step S300). The generated observation light is applied through objective lens 40 to the object under measurement. Then, the observation reflected light generated at the object under measurement is applied through pinhole mirror 32 for example to observation-purpose camera 38. Receiving the observation reflected light, observation-purpose camera 38 starts outputting to controller 2 an image signal according to the observation reflected light (step S302).

Position control portion 2B of controller 2 receives a search range of the XY plane (step S304), and sets a plurality of search points in the search range (step S306). Position control portion 2B of controller 2 then successively obtains the focus position at each search point as described below.

Position control portion 2B of controller 2 moves the object under measurement (stage 50) such that the observation light is applied to the first search point (step S308), and performs the focusing process to obtain focus position Mz (step S310). Position control portion 2B of controller 2 associates the obtained focus value with the coordinates of the search point and stores them (step S312).

Subsequently, position control portion 2B of controller 2 determines whether or not the current coordinates of the object under measurement (stage 50) are the coordinates of the last search point (step S314). When current coordinates of the object under measurement (stage 50) are not the coordinates of the last search point (NO in step S314), position control portion 2B of controller 2 further moves the object under measurement (stage 50) such that the following search point is irradiated with the observation light (step S316), and the operations from step S310 are performed again.

When the current coordinates of the object under measurement (stage 50) are the coordinates of the last search point (YES in step S314), position control portion 2B of controller 2 determines an approximate function based on the coordinates of the search points corresponding to a plurality of focus values as obtained (step S318). Then, position control portion 2B of controller 2 calculates the reflection point for the determined approximate function (step S320), and determines that the coordinates on the XY plane corresponding to the calculated reflection point are the spatial reflection point of object under measurement OBJ (step S322).

Further, position control portion 2B of controller 2 moves the object under measurement along the XY plane such that the spatial reflection point determined in step S322 is irradiated with the measurement light and the observation light (step S324), and further performs the focusing process (S326).

The above-described process procedure is used to search for the spatial reflection point of the object under measurement.

(3) Mathematical Search Method

The mathematical search method obtains focus position Mz at initial coordinates set in advance in a search region, and repeatedly searches for a reflection point according to a mathematical algorism starting from the initial coordinates. This method is applied in principle to the case where one reflection point is present in the search region. Since the method uses a relatively small number of search points, the spatial reflection point can be searched for at a higher speed.

According to the mathematical search method as described above, a search vector is calculated based on a calculated focus position for example, and the search point is successively determined based on the search vector. As the method of calculating the search vector as described above, various algorisms have been proposed. Typically the following three algorisms can be used.

(i) Downhill simplex method

(ii) Powel's method

(iii) Conjugate gradient method

As to details of these algorisms, see for example “Numerical Recipes In C: The Art of Scientific Computing,” Cambridge University Press, 1988-1992, pp. 408-425.

According to the first embodiment of the present invention, the observation light is masked according to the observation reference image and then applied to the object under measurement. Thus, the observation reference image is projected on the object under measurement. The observation light is reflected from the object under measurement to generate the observation reflected light including a reflected image corresponding to the observation reference image. Since the reflected image corresponding to the observation reference image has a sufficient contrast (difference between light and dark parts) generated because of the presence of the observation reference image, the focus state of the observation light on the object under measurement can be determined accurately regardless of the reflectance of the object under measurement.

The measurement light and the observation light are applied through the common condensing optical system to the object under measurement. Therefore, the focus state of the observation light on the object under measurement and the focus state of the measurement light on the object under measurement can be regarded as substantially identical to each other.

Therefore, even in the case where the object under measurement has a relatively low reflectance, the focus can be adjusted easily based on the observation reflected light including the reflected image corresponding to the observation reference image.

Further, according to the first embodiment of the present invention, the focus position having the maximum focus value is obtained at each of a plurality of points of the object under measurement, and the spatial reflection point of the object under measurement is searched for based on the obtained focus positions. Therefore, the measurement light can be surely applied to the topmost point or the like of the convex-shaped object under measurement such as lens. Accordingly, optical characteristics of the spherical object under measurement can be measured more accurately.

### Second Embodiment

Regarding the optical characteristic measuring apparatus in the first embodiment of the invention as described above, the configuration is explained where beam splitter 20 is disposed on the propagation path of the reflected light (measurement reflected light and observation reflected light) to inject the observation light. The position where the observation light is injected, however, is any position as long as the position is present on an optical path from measurement-purpose light source 10 to objective lens 40 which constitutes a condensing optical system. Accordingly, regarding a second embodiment of the present invention, a description will be given of a configuration where an observation light is injected on an optical path from measurement-purpose light source 10 to beam splitter 30.

FIG. 15 is a schematic configuration diagram of an optical characteristic measuring apparatus 100B in the second embodiment of the present invention.

Referring to FIG. 15, optical characteristic measuring apparatus 100B in the second embodiment of the present invention differs from optical characteristic measuring apparatus 100A shown in FIG. 1 in that the position of beam splitter 20 is changed to a position on an optical path from measurement-purpose light source 10 to beam splitter 30, and respective positions of observation-purpose light source 22, optical fiber 24 and emitting portion 26 are changed according to the positional change of the beam splitter. Other functions and elements are similar to those of optical characteristic measuring apparatus 100A shown in FIG. 1, and the detailed description thereof will not be repeated.

Optical characteristic measuring apparatus 100B in the present embodiment allows a reflected light (measurement reflected light and observation reflected light) from an object under measurement to pass through only one beam splitter 30. Beam splitter 30 is typically formed of a half mirror. A theoretical transmittance of the half mirror is 50% as the name indicates. Therefore, the light intensity of the light after passing through the half mirror is half (50%) that of the light intensity before passing therethrough. Therefore, the number of beam splitters through which the reflected light passes can be decreased to reduce the amount of attenuation of the reflected light entering spectroscopic measuring portion 60. Therefore, the SN (Signal to Noise) ratio of the spectrum detected by spectroscopic measuring portion 60 can be kept higher.

According to the second embodiment of the present invention, the effect that the precision in measurement can be further improved is obtained in addition to the effect obtained by the above-described first embodiment.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An optical characteristic measuring apparatus comprising:
a measurement-purpose light source generating a measurement light including a component in a wavelength range for measurement of an object to be measured;
an observation-purpose light source generating an observation light including a component that can be reflected from said object;
a condensing optical system to which said measurement light and said observation light are applied and which condenses the applied light;
an adjusting mechanism capable of changing a positional relation between said condensing optical system and said object;
a light injecting portion, at a predetermined position on an optical path from said measurement-purpose light source to said condensing optical system, injecting said observation light;
a mask portion, at a predetermined position on an optical path from said observation-purpose light source to said light injecting portion, masking a part of said observation light such that an observation reference image is projected;
a light separating portion separating a reflected light generated at said object into a measurement reflected light and an observation reflected light;
a focus state determining portion determining a focus state of said measurement light on said object, based on a reflected image included in said observation reflected light and corresponding to said observation reference image; and
a position control portion controlling said adjusting mechanism according to a result of determination of said focus state.

2. The optical characteristic measuring apparatus according to claim 1, further comprising an image pickup receiving said observation reflected light and outputting an image signal according to the observation reflected light, wherein
said focus state determining portion outputs a value indicative of said focus state, based on said image signal from said image pickup.

3. The optical characteristic measuring apparatus according to claim 2, wherein
said focus state determining portion outputs the value indicative of said focus state, based on a signal component included in said image signal according to the observation reflected light and corresponding to a pre-set region.

4. The optical characteristic measuring apparatus according to claim 2, wherein
said adjusting mechanism is configured to be able to move said object along a light axis of said measurement light, and
said position control portion adjusts a distance between said condensing optical system and said object along said light axis, such that the value indicative of said focus state is a maximum.

5. The optical characteristic measuring apparatus according to claim 2, wherein
said adjusting mechanism is configured to be able to move said object along a plane orthogonal to a light axis of said measurement light, and
said position control portion obtains, for each of a plurality of coordinates on said plane, a position of said object in a direction of said light axis at which the value indicative of said focus state is a maximum, said position being obtained as a focus position of each coordinate, and said position control portion searches for a spatial reflection point of said object, based on a plurality of said focus positions as obtained.

6. The optical characteristic measuring apparatus according to claim 5, wherein
said position control portion obtains a plurality of said focus positions respectively for a plurality of coordinates along a first direction on said plane, and obtains a plurality of said focus positions respectively for a plurality of coordinates along a second direction orthogonal to said first direction on said plane, and said position control portion determines a spatial reflection point of said object, based on a coordinate at which said focus position has one of maximum and minimum value, in each of said first direction and said second direction.

7. The optical characteristic measuring apparatus according to claim 5, wherein
said position control portion moves said object along said plane such that said measurement light and said observation light are applied to said spatial reflection point, and thereafter adjusts a distance between said condensing optical system and said object along said light axis, such that the value indicative of said focus state is a maximum.

8. The optical characteristic measuring apparatus according to claim 2, wherein
said image pickup outputs, as said image signal, brightness data of said observation reflected light corresponding to each of a plurality of pixels arranged in a matrix, and
said focus state determining portion outputs the value indicative of said focus state, based on a histogram of the brightness data corresponding to each pixel.

9. A method of adjusting a focus for an optical characteristic measuring apparatus,
said optical characteristic measuring apparatus including:
a measurement-purpose light source generating a measurement light including a component in a wavelength range for measurement of an object to be measured;
an observation-purpose light source generating an observation light including a component that can be reflected from said object;
a condensing optical system to which said measurement light and said observation light are applied and which condenses the applied light;
an adjusting mechanism capable of changing a positional relation between said condensing optical system and said object;
a light injecting portion, at a predetermined position on an optical path from said measurement-purpose light source to said condensing optical system, injecting said observation light;
a mask portion, at a predetermined position on an optical path from said observation-purpose light source to said light injecting portion, masking a part of said observation light such that an observation reference image is projected; and
a light separating portion separating a reflected light generated at said object into a measurement reflected light and an observation reflected light, and
said method of adjusting a focus comprising the steps of:
starting generation of said observation light from said observation-purpose light source;
determining a focus state of said measurement light on said object, based on a reflected image included in said observation reflected light and corresponding to said observation reference image; and
controlling said adjusting mechanism according to a result of determination of said focus state.

10. The method of adjusting a focus according to claim 9, wherein
said optical characteristic measuring apparatus further includes an image pickup receiving said observation reflected light and outputting an image signal according to the observation reflected light,
said adjusting mechanism is configured to be able to move said object along a light axis of said measurement light,
said step of determining a focus state includes the step of outputting a value indicative of said focus state based on said image signal from said image pickup, and
said step of controlling said adjusting mechanism includes the step of adjusting a distance between said condensing optical system and said object along said light axis, such that the value indicative of said focus state is a maximum.
